(19) United States
(12) Patent Application Publication
(10) Pub. No.: US 2007/0172796 A1
(43) Pub. Date: Jul. 26, 2007

(54) OSSEO-INTEGRATED DENTAL IMPLANT

(76) Inventors: Young Keun HYUN, Seoul (KR); Jong Jin KWON, Seoul (KR)

Correspondence Address: LOWE HAUPTMAN BERNER, LLP, 1700 DIAGONAL ROAD, SUITE 300, ALEXANDRIA, VA, 22314, US

(21) Appl. No.: 11/625,701

(22) Filed: Jan. 22, 2007

(30) Foreign Application Priority Data
Jan. 20, 2006 (KR) 10-2006-0006450

(51) Int. Cl. A61C 8/00

(52) U.S. Cl. 433/174; 433/173

(57) ABSTRACT

An osseo-integrated dental implant comprising a polished band and a protuberance is disclosed.

The polished band is located between a one-third and a two-third position of an overall length of a root of the implant as measured from an upper end of the root and polished in a circumferential direction to have a surface roughness of below 0.5 μm. A width of the polished band is 0.5 mm to 1.0 mm when the overall length of the root is below 8 mm, and 0.5 mm to 1.2 mm when the overall length of the root is between 9 mm and 12 mm, and 0.5 mm to 1.5 mm when the overall length of the root is above 13 mm. An external diameter of the polished band is smaller than an external diameter of a ridge of screw located at the upper portion of the root. A protuberance has a roughness same as the polished band, protruded from the polished band with a shape of a ridge of screw.

### RELATED APPLICATIONS

The present application is based on, and claims priority from, Korean Application Number 10-2006-0006450, filed Jan. 20, 2006, the disclosure of which is hereby incorporated by reference herein in its entirety.

### BACKGROUND OF THE INVENTION

1. Field of the Invention

The present invention relates to an osseo-integrated dental implant, and more particularly, to an osseo-integrated dental implant increasing contact area of the osseo and the osseo-integrated dental implant and strengthening a structural strength of the osseo-integrated dental implant.

2. Description of the Related Art

The osseo-integrated dental implant (hereinafter referred to as “implant”) is also called an endosseous implant. The clinical application of the implant is on the rapid increase because of high clinical success rate and excellent function of the implant.

However in the clinically successful implants, since the osseeointegration is imperfect or the bone defect is generated at the cervical portion of the implants, failures of the implants frequently happen. Therefore, many sufferers will complain of pain due to disease of the surroundings of the implants.

The failures of the implants are caused by repeated microfracture of the bone due to overload to the implants or bacterial infection of the surrounding bone of the implants, etc. However, all the implants pass through peri-implantitis regardless of causes of the failures. This peri-implantitis gives rise to inflammation of mucosa, loss of attached gingiva, exposure of a cervical portion of the implant and loss of the surrounding bone, etc. Therefore, the peri-implantitis has to be properly treated at an initial stage to maintain functions of the implant.

Conventionally, the periosurgery is performed in the surroundings of the implant and the toxin, which is formed in the root portion of the infected implantis, is removed in order to treat the peri-implantitis at the initial stage. Also, the surface of the screw of the implant or the unevenness of a plasma surface or coated surface by hydroxypatite is removed and then the surface is highly polished.

However, the implant according to the prior art has a disadvantage in that it is very difficult to accurately polish the infected surface of a subgingival area in a root portion of the implant by a curette for dental implant or a dental high speed burr for treatment of the peri-implantitis. Also, the implant according to the prior arts has a problem in that a bone defect and inflammation may be rapidly and downwardly spread due to rough surface characteristics when bone damage occurs at a cervical portion of the implant.

U.S. Pat. No. 6,220,861, entitled “OSSEO-INTEGRATED DENTAL IMPLANT” issued Apr. 7, 2001, discloses an implant comprising a polished band which is located between one-third position and two-third position of an overall length of a root of the implant as measured from an upper end of a root of the implant and polished in a circumferential direction with a surface roughness below 0.5 μm, wherein a width of the polish band is 0.5 mm to 1.0 mm when the length of the root is below 8 mm and the width of the polish band is 0.5 mm to 1.2 mm when the length of the root is 9 mm to 12 mm and the width of the polish band is 0.5 mm to 1.5 mm when the length of the root is above 13 mm. This patent belongs to inventors of the present invention and is incorporated herein by reference.

However, the above described implant comprising the polished band has the problems.

First, when a diameter of the polished band is larger than a minimum diameter of other portion of the root, where the polished band is not located and a valley of screw is formed, a contact area of the root of the implant and the osseo decreases so that the implant is loosely fixed in the osseo at an initial stage. As shown in FIG. 1A and FIG. 1B, a hole 21 is formed in the osseo 20 and the root 10 of the implant is screwed into the hole 21. For example, if the maximum diameter of the root of the implant is 3.75 mm, the diameter of the hole 21 is 3.2 mm. That is, the maximum diameter of the root of the implant is bigger than the diameter of the hole 21. If the diameter of the polished band is same as the maximum diameter of the root of the implant, the diameter of the hole 21 is enlarged when the root of the implant is screwed into the hole 21. An empty space between a ridge of the screw 12 of the root 10 at the upper portion of the implant and the osseo 20 is formed so that the contact area of the implant and the osseo 20 is decreased.

Second, as shown in FIG. 2, a tooth 30 is fitted with the upper end of the implant 10. Inner hollow with a diameter of 2.0 mm is formed in a longitudinal direction of the root of the implant 10 and a screw 40 with a diameter of 2.0 mm is inserted and screwed into the hollow in order to fit the tooth 30 with the upper end of the implant 10. An external thickness of the root of the implant 10 becomes 0.875 mm and an external thickness of the polished band 11 is 0.275 mm when the polish band 11 is polished by 0.6 mm, which is same as the height of the screw thread. Thus, the implant may be easily broken when 134N which is an average maximum occlusal force is applied on the polished band 11.

The problem of the implant with the polished band in accordance with the prior art is that if the diameter of the polished band increases, the contact area of the implant and the osseo decreases and if the diameter of the polished band decreases, the structural strength of the implant gets decreases.

### SUMMARY OF THE INVENTION

It is an object of the present invention to provide a new and improved implant to increase the contact area of the implant and the osseo.

It is another object of the present invention to provide a new and improved implant to strengthen the structural strength of the implant.

In order to accomplish these objects in accordance with the present invention, there is provided an implant comprising the polished band located between a one-third and a two-third position of an overall length of the root of the implant as measured from an upper end of the root, polished in a circumferential direction to have a surface roughness of below 0.5 um and a protuberance having a roughness same as the polished band, protruded from the polished band with a shape of the screw thread, wherein a width of the polished band is 0.5 mm to 1.0 mm when the overall length of the root is below 8 mm, and 0.5 mm to 1.2 mm when the overall length of the root is between 9 mm and 12 mm, and 0.5 mm to 1.5 mm when the overall length of the root is above 13 mm, wherein a external diameter of the polished band is smaller than a external diameter of a screw thread located in the upper end of the root.

Preferably, the external diameter of the band is larger by 1 mm than the external diameter of the valley of screw located at the upper portion of the root.

More preferably, a width of the band is 0.5 mm when the overall length of the root is below 8 mm, and 0.5 mm to 1.0 mm when the overall length of the root is 9 mm to 12 mm, and 0.5 mm to 1.2 mm when the overall length of the root is above 13 mm.

In accordance with the present invention, the diameter of the band is smaller than the diameter of the screw thread of the upper end of the root so that the contact area of the osseo and the upper end of the root is increased.

In accordance with the present invention, the protuberance is formed on the polished band so that the structural strength of the polished band portion is increased.

For a better understanding of the invention, its operating advantages and specific objects attained by its uses, reference is made to the accompanying drawings and descriptive matter in which the preferred embodiments of the invention are illustrated.

### BRIEF DESCRIPTION OF THE DRAWINGS

These and other objects and advantages of the invention will become apparent and more readily appreciated from the following description of the preferred embodiments, taken in conjunction with the accompanying drawings of which:

FIG. 1A and FIG. 1B are illustrating a step of implanting a root of an implant comprising a polished band into a osseo according to the prior art;

FIG. 2 is a fragmentary sectional view illustrating a state that a tooth is combined onto a root of an implant comprising a polished band;

FIG. 3 is a front view illustrating an embodiment of an implant according to the present invention.

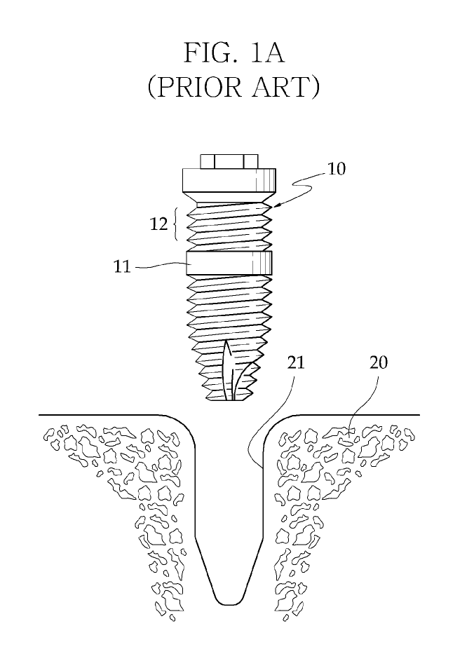

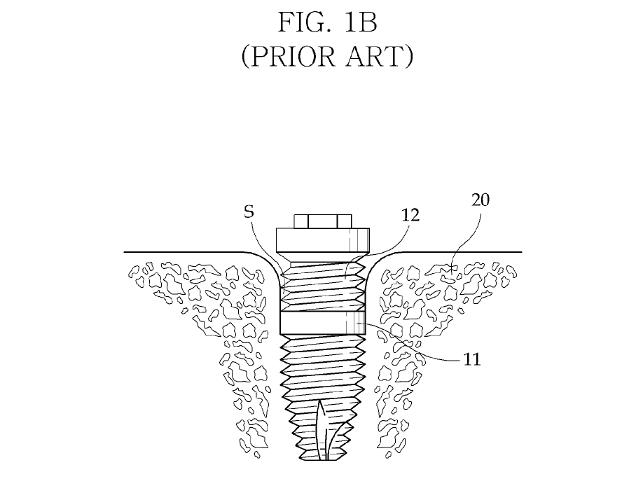

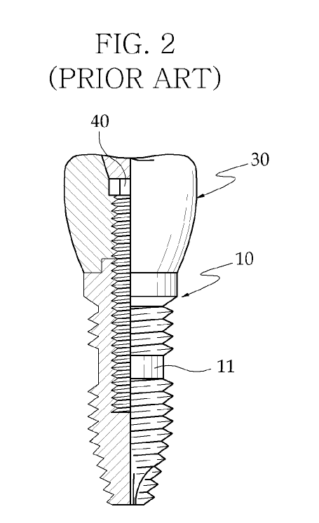

### DETAILED DESCRIPTION OF THE INVENTION

This invention will be described in further detail by way of embodiments with reference to the accompanying drawings.

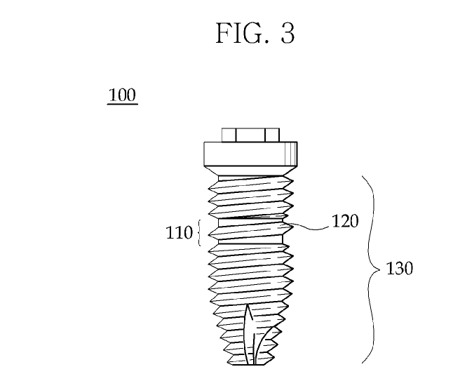

FIG. 3 is a front view illustrating an embodiment of an implant according to the present invention.

Referring to FIG. 3, a polished band 110 is located at a predetermined position of the root 130 of the implant 100, wherein the surface of the polished band 110 is machine-polished with a roughness of below 0.5 μm. The surface of the polished band 110 can be a flat or preferably concave shape. On the other hand, the surface of the polished band 110 can be a trumpet shape so that a diameter becomes smaller from an upper portion to a lower portion of the polished band 110. The diameter of the polished band 110 is smaller than the diameters of a ridge of screws located at the upper portion of the root 130 of the implant 100.

According to the present invention, dentists can easily operate dental high speed burrs when a polishing method is applied to an upper portion of the polish band 110 by forming the polished band 110 on the implant 100. The implant treatment is generally evaluated as a failure when the degree of bone loss exceeds one-third in comparison with an initially implanted length of the implant regardless of overall length of the implant. Therefore, the implant according to the prior art is maintained by conventional methods when the degree of bone loss is below one-third of the implanted length of the implant, and treatment of dental implant accompanying a polishing of an infected area is applied to the implant to lengthen a lifetime of the implant when the degree of bone loss is above one-third of the implanted length of the implant. Accordingly, preferably, the polished band 110 is located between a one-third position and a two-third position of overall length of the root 130 of the implant 100 as measured from an upper end of the root 130.

The polished band 110 has various widths within the range of 0.5 mm to 1.5 mm, in accordance with overall length of the root 130, a patient's hygiene, a position of the implant 100 and bone quality, etc. The polished band 110 is 0.5 mm to 1.0 mm in width when the overall length of the root 130 is below 8 mm, and is 0.5 mm to 1.2 mm in width when the overall length of the root 130 is between 9 mm and 12 mm, and is 0.5 mm to 1.5 mm in width when the overall length of the root 130 is above 13 mm.

Preferably, the width of the polished band 110 is 0.5 mm when the overall length of the root 130 is below 8 mm, and is 0.5 mm to 1.0 mm when the overall length of the root 130 is between 9 mm and 12 mm, and is 0.5 mm to 1.2 mm when the overall length of the root 130 is above 13 mm. The smaller width of the polished band 110 can increase the structural strength of the implant 100.

Preferably, the external diameter of the polished band 130 is larger by 1 mm than an external diameter of a valley of the screw located at the upper portion of the root 130. This can also increase the structural strength of the implant 100.

To determine the location, the surface roughness and the width of the polished band 110, analysis of a distribution of force on the implant 100 using a finite element method and a change of contact area of the osseo and the implant 100 is carried out in long time. Also, study of an affinity, a change of osseo formation and somatometry through animal experiment is performed in order to confirm an influence on body.

A protuberance 120 is formed on the polished band 110. The protuberance 120 has the same surface roughness as the polished band 110 and the protuberance 120 has the shape of a ridge of screw. It is desirable that a diameter of the protuberance 120 is smaller than the maximum diameter of the ridge of screw located at the upper portion of the root 130. The protuberance 120 may have various shapes including the shape of the ridge of screw.

The invention is in no way limited to the embodiments described hereinabove. Various modifications of disclosed embodiments as well as other embodiments of the invention will become apparent to persons skilled in the art upon reference to the description of the invention. It is therefore contemplate that the appended claims will cover any such modification or embodiments as fall within the true scope of the invention.

What is claimed is:

1. An osseo-integrated dental implant, comprising:
a polished band located between a one-third and a two-third position of an overall length of a root of the osseo-integrated dental implant as measured from an upper end of the root and polished in a circumferential direction to have a surface roughness of below 0.5 μm; and
a protuberance having the roughness same as the polished band, protruded from the polished band with a shape of a ridge of screw,
wherein a width of the polished band is 0.5 mm to 1.0 mm when the overall length of the root is below 8 mm, and 0.5 mm to 1.2 mm when the overall length of the root is between 9 mm and 12 mm, and 0.5 mm to 1.5 mm when the overall length of the root is above 13 mm,
wherein an external diameter of the polished band is smaller than an external diameter of a ridge of screw located at the upper portion of the root.

2. The osseo-integrated dental implant as claimed in claim 1, wherein the external diameter of the polished band is larger by 0.1 mm than an external diameter of a valley of screw located at the upper portion of the root.

3. The osseo-integrated dental implant as claimed in claim 1, wherein the width of the polished band is 0.5 mm when the overall length of the root is below 8 mm, and 0.5 mm to 1.0 mm when the overall length of the root is 9 mm to 12 mm, and 0.5 mm to 1.2 mm when the overall length of the root is above 13 mm.
